(19) United States
(12) Patent Application Publication
(10) Pub. No.: US 2025/0229276 A1
(43) Pub. Date: Jul. 17, 2025

(54) SWING ROTOR ASSEMBLY FOR CENTRIFUGE

(71) Applicant: MIRACELL CO., LTD., Seoul (KR)

(72) Inventor: Hyun Soon SHIN, Seoul (KR)

(73) Assignee: MIRACELL CO., LTD., Seoul (KR)

(21) Appl. No.: 19/016,751

(22) Filed: Jan. 10, 2025

(30) Foreign Application Priority Data
Jan. 16, 2024 (KR) 10-2024-0006624

(51) Int. Cl. B04B 5/04; B04B 9/08

(52) U.S. Cl. CPC B04B 5/0421; B04B 9/08

(57) ABSTRACT

The present invention relates to a swing rotor assembly for a centrifuge, and more particularly, to a swing rotor assembly for a centrifuge equipped with a bucket fixing portion that fixes the bucket's position to facilitate separation and discharge after centrifuging a sample such as blood or bone marrow put into a decanting kit mounted on a bucket of a centrifuge. According to the present invention, the swing rotor assembly comprising: a rotor head unit consisting of a U-shaped curved portion formed symmetrically to mount the bucket and a bucket fixing portion formed on one side of the bottom surface of the U-shaped curved portion to fix the position of the decanting kit tilted by centrifugal force; a bucket in which a decanting kit is inserted and mounted, installed in the U-shaped curved portion, and rotated up and down by centrifugal force according to the rotation of the rotor head unit; and a driving unit consisting of a rotating shaft portion mounted on the central bottom of the rotor head unit, a driving transmission portion that transmits driving power to the rotating shaft portion, and a power supply portion connected to the rotating shaft portion to supply DC power to the bucket fixing portion.

### TECHNICAL FIELD

The present invention relates to a swing rotor assembly for a centrifuge, and more particularly, to a swing rotor assembly for a centrifuge equipped with a bucket fixing portion that fixes the bucket's position to facilitate separation and discharge after centrifuging a sample such as blood or bone marrow put into a decanting kit mounted on a bucket of a centrifuge.

### BACKGROUND ART

When a suspension with a floating material is left, high-density materials slowly sink to the bottom under the influence of gravity and low-density materials slowly move to the upper layer, and this process is called sediment.

As such, when materials with different densities are mixed, the sediment occurs, and the mixture may be separated over time according to a density difference. Since the density difference between mixtures increases as the gravity, a force for separating the mixture, increases, the sediment may be accelerated by artificially increasing the gravity.

In other words, the sediment may be easily accelerated using a centrifugal force instead of the gravity, and this process is called centrifugation. The centrifuge is a machine used to separate, purify, and concentrate materials with different components or specific gravity using a principle of centrifugation, and may be divided into medical use, wastewater treatment, uranium enrichment, production, and experimental use depending on the purpose of use.

In particular, the medical centrifuge is used for separating components for analysis of blood, urine, saliva, and the like. For example, platelet-rich plasma (PRP) obtained by centrifugation of bone marrow or blood refers to a highly enrichment plasma component in which the platelet is richer than normal bone marrow or blood. For example, the PRP is injected into a damaged area such as ligament and cartilage to be used for reconstructing the damaged area and uses own bone marrow or blood, so that there are no side effects and the treatment effect is quick.

Based on this technical idea, in Korean Patent Registration No. 10-1387433, there is disclosed a centrifugal separator and a bucket capable of using both functions of a swing rotor and an angle rotor so as to implement the function of the angle rotor in the swing rotor by replacing an appropriate bucket without replacing the entire rotor.

According to the related art, it is theoretically possible to increase a treatment capacity by forming a plurality of accommodating units in the bucket, to provide a bucket corresponding to various storage containers by varying the size and shape of the accommodating unit in the bucket, and to simultaneously perform separation by a swing rotor and separation by an angle rotor even if one swing rotor is subjected to a single centrifugation process according to the features.

However, the centrifugation of the sample may be easy according to the advantages described so far, but in order to inject the separated components into another space (chamber) after centrifugation inside the sample container, the sample should be discharged while maintaining an inclined state at a predetermined angle, but there is a problem in that it is not easy to maintain an angle for discharging the sample.

In order to solve this problem, this applicant proposed an angle maintenance means using a solenoid valve in Patent No. KR 10-2236880.

However, when using a solenoid valve, there was a problem that the vibration was severe depending on the difference in the weight of the battery because the rotor head had to be equipped with the solenoid valve and the battery to operate the solenoid valve.

In addition, due to the short operating time of the solenoid valve, two solenoids had to be used, which complicated the structure, made it difficult to manufacture, and increased the manufacturing cost of the centrifuge.

### DISCLOSURE

### Technical Problem

An object of the present invention is to solve the problems and to provide a swing rotor assembly for centrifuge that can simplify the structure of the bucket fixing portion to maintain the inclination angle of the bucket close to the horizontal by centrifugal force when the rotor rotates and drive the bucket fixing portion by constant power supply without using a battery.

### Technical Solution

According to an aspect of the present invention, there is provided a swing rotor assembly for centrifuge that is mounted and rotated inside a housing of the centrifuge, the swing rotor assembly comprising: a rotor head unit consisting of a U-shaped curved portion formed symmetrically to mount the bucket and a bucket fixing portion formed on one side of the bottom surface of the U-shaped curved portion to fix the position of the decanting kit tilted by centrifugal force; a bucket in which a decanting kit is inserted and mounted, installed in the U-shaped curved portion, and rotated up and down by centrifugal force according to the rotation of the rotor head unit; and a driving unit consisting of a rotating shaft portion mounted on the central bottom of the rotor head unit, a driving transmission portion that transmits driving power to the rotating shaft portion, and a power supply portion connected to the rotating shaft portion to supply DC power to the bucket fixing portion.

The bucket fixing portion may be configured by an electromagnet mounted on the bottom end of one side of the U-shaped curved portion and operated by receiving DC power from the power supply portion.

The bucket may be configured by a circular ring in which the decanting kit is inserted and mounted, a pair of ring support plates connected to both bottom surfaces of the circular ring and rotatably mounted on the U-shaped curved portion, and an attachment protrusion mounted on the ring support plate corresponding to the position of the electromagnet in order to be attached to the electromagnet when the ring support plate rotates at a certain angle by centrifugal force.

The driving transmission portion may be configured by a driven belt pulley mounted on the rotating shaft portion to receive rotational force, a driving belt pulley that receives rotational force from the motor to transmit rotational force to the driven belt pulley, a driving transmission belt connecting the driving belt pulley and the driven belt pulley, and a motor that rotates the driving belt pulley.

The driving transmission belt may be configured by timing belt or V-belt.

The driving transmission portion may be configured by a motor driving the rotating shaft portion.

The power supply portion may be configured by a slip ring to be mounted on the rotating shaft portion and to supply DC power to the electromagnet.

### Advantageous Effects

The swing rotor assembly for centrifuge according to the present invention has the advantage of improving productivity and lowering unit prices because the structure of the bucket fixing portion equipped in the rotor head unit is simple in separating the components of the sample according to the rotation of the rotor head portion.

In addition, since the bucket fixing portion is made of an electromagnet and can receive constant power supply, it is easy to balance the rotor head unit and significantly reduces vibration or noise.

In addition, since the decanting kit can be maintained at a certain angle for a desired time by the bucket fixing portion, there is an advantage of increasing the separation efficiency of the sample separated by centrifugation.

### DESCRIPTION OF DRAWINGS

FIG. 1 is a perspective view of a centrifuge equipped with a swing rotor assembly for centrifuge according to the present invention.

FIG. 2 is a perspective view with the lid of the centrifuge of FIG. 1 open.

FIG. 3 is an exploded perspective view of a swing rotor assembly for centrifuge installed in the centrifuge of FIG. 1.

FIG. 4 is a perspective view of a rotor head portion with the bucket.

FIG. 5 is a bottom perspective view of the rotor head portion on which the bucket of FIG. 4 is mounted.

FIG. 6 is a perspective view of a bucket according to the present invention.

FIG. 7 is a perspective view of a first embodiment of a driving unit according to the present invention.

FIGS. 8 and 9 are perspective views of a state which some components of the driving unit of FIG. 7 are deleted.

FIG. 10 is an operational state perspective view illustrating a state in which buckets are fixed to the rotor head unit according to the present invention.

FIG. 11 is a bottom perspective view of FIG. 10.

FIG. 12 is a perspective view of a second embodiment of a driving unit according to the present invention.

FIG. 13 is a perspective view illustrating a state in which some components are deleted from the driving unit of FIG. 12.

FIG. 14 is an exploded perspective view of the driving unit of FIG. 13.

### MODES OF THE INVENTION

Hereinafter, preferred embodiments of the present invention will be described in detail with reference to the accompanying drawings to the extent that a person with ordinary skill in the art to which the invention pertain is able to easily implement the present invention. At first, when reference numerals refer to components of each drawing, it is to be noted that although the same components are illustrated in different drawings, the same components are denoted by the same reference numerals as possible. In the description of the present invention, a detailed explanation of related known configurations or functions will be omitted when it is determined to obscure the subject matter of the present invention.

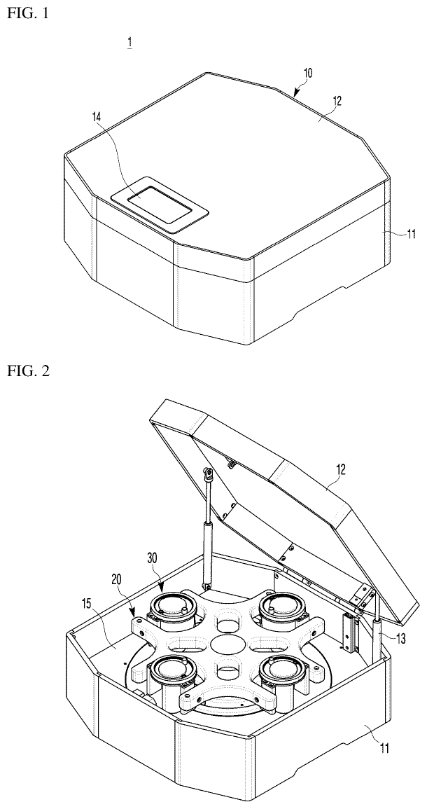

FIGS. 1 and 2 are perspective views of a centrifuge 1 in which a swing rotor assembly 20 for centrifuge according to the present invention is mounted. As shown in the drawings, the centrifuge 1 includes a centrifuge housing 10, and a swing rotor assembly 20 mounted on the centrifuge housing 10. The centrifuge housing 10 includes a case 11, a cover 12 for covering the case 11, a cylinder device 13 connected to the case 11 and the cover 12 to control the opening and closing of the cover 12, a controller 14, a support plate 15 installed inside the case 11 to support the swing rotor assembly 20, and a base plate 17 installed inside the case 11 to support the swing rotor assembly 20 from the lower side. An LED module 16 irradiating an LED light is further included inside the support plate 15.

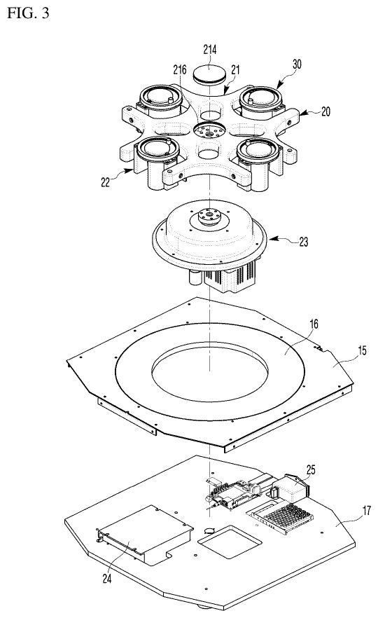

FIG. 3 is an exploded perspective view of components inside a centrifuge 1 according to the present invention. As shown in the drawing, a switching mode power supply (SMPS) 25 and a motor drive 24 are mounted on the base plate 17 in the internal configuration. A support plate 15 for dividing the inside of the centrifuge 1 is provided on the upper portion of the base plate 17. The LED module 16 is mounted in a circular ring shape inside the support plate 15. The swing rotor assembly 20 is mounted inside the ring-shaped LED module 16. The swing rotor assembly 20 includes a driving unit 23 penetrating through the central hole of the LED module 16, a rotor head unit 21 mounted on the driving unit 23, and a bucket 22 mounted on the rotor head unit 21.

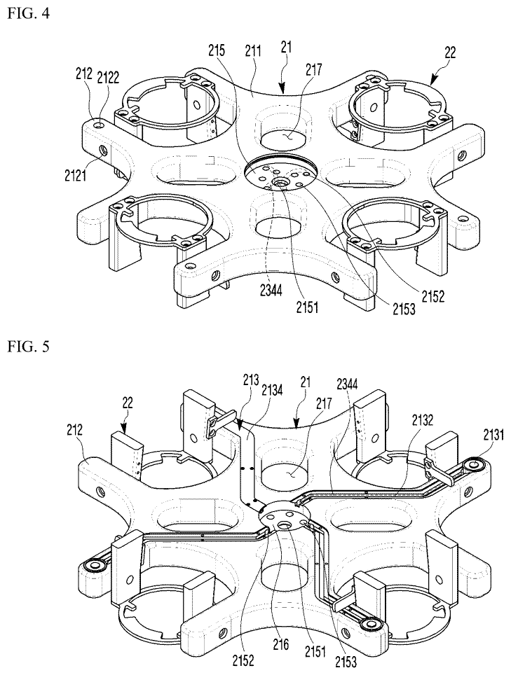

FIGS. 4 and 5 are perspective views of the rotor head unit 21 and the bucket 22 of the swing rotor assembly 20 according to the present invention. FIG. 4 is a front perspective view and FIG. 5 is a bottom perspective view. As shown in FIGS. 4 and 5, the rotor head unit 21 is composed of a head body 211, a U-shaped curved portion 212 symmetrically formed at four locations of the head body 211 and to mount the bucket 22, and a bucket fixing portion 213 formed at one side of the bottom surface of the U-shaped curved portion 212 to fix the position of the decanting kit 30 inclined by centrifugal force. The head body 211 is drawn in a ‘+’ shape in the drawing, but may be formed in a ‘−’ shape. Four U-shaped curved portions 212 are formed in the ‘+’ shape, and two U-shaped curved portions 212 are formed in the ‘−’ shape. In addition, the head body 211 may be further formed with a through hole 217 for reducing weight. An upper joint groove 215 to which a fastening member for fixing the driving unit 23 is fastened is formed in the center of the front of the head body 211, and a lower joint groove 216 into which the shaft joint 2312 of the driving unit 23 is inserted is formed in the center of the bottom of the head body 211. The shaft joint 2312 is inserted into the lower joint groove 216, and the shaft joint 2312 is fixedly fastened to the shaft joint 2312 using a fastening member such as a bolt (not shown) to the fastening hole 2153 formed in the upper joint groove 215 and penetrating to the lower joint groove 216, thereby connecting the head body 211 to the driving unit 23. A groove cover 214 blocks the upper joint groove 215, and a wire through hole 2151 through which an electric wire 2344 connected from the rotating shaft 2311 to the upper side passes is formed in the center of the upper joint groove 215. A wire discharge hole 2152 is formed outside the fastening hole 2153 to connect the wire 2344 to the bucket fixing portion 213 formed on the bottom surface of the U-shaped curved portion 212. As shown in FIG. 4, an electric wire 2344 connected upward through a shaft through hole 2313 formed at the center of the rotating shaft 2311 is connected to an electromagnet 2131 of the bucket fixing portion 213 through the wire discharge hole 2152 in the upper joint groove 215. A bucket 22 is installed in the U-shaped curved portion 212. Accordingly, the hinge shaft hole 2121 is provided in which a hinge shaft (not shown) for rotating the bucket 22 is mounted on both sides of the U-shaped curved portion 212. The bucket 22 is rotatably mounted on the hinge shaft hole 2121 by the hinge shaft. Accordingly, when the rotor head unit 21 rotates, the bucket 22 may be lifted upward by centrifugal force. A bucket fixing portion 213 is formed on the bottom surface of one side of the U-shaped curved portion 212. The bucket fixing portion 213 includes an electromagnet 2131 in which power is supplied from the power supply portion 234 to maintain a state in which the bucket 22 is rotated at a predetermined angle, and an electric wire seating groove 2132 in which an electric wire connected to the electromagnet 2131 is seated. The electromagnet 2131 is inserted into a groove formed on the bottom surface of the U-shaped curved portion 212, and a fastening member is fastened to the fastening hole 2122 formed in the front surface of the U-shaped curved portion 212 to fix and mount the electromagnet 2131. In addition, the seating groove cover 2134 for covering the electric wire seating groove 2132 is fastened to prevent the electric wire from being separated.

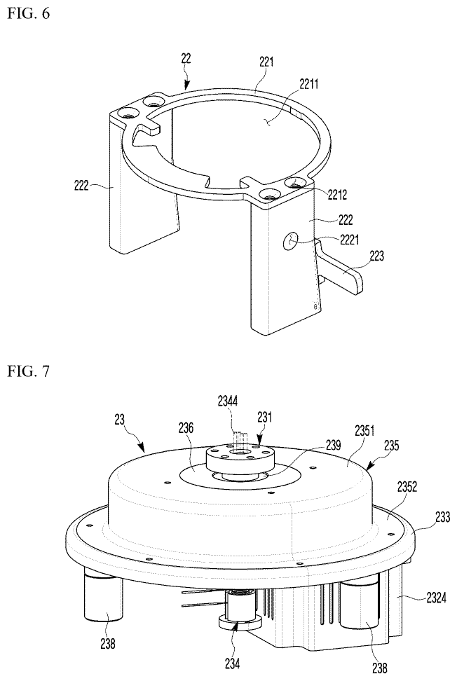

The bucket (22) is illustrated in FIG. 6. The bucket 22 consists of a circular ring 221 in which the decanting kit 30 is inserted, a pair of ring support plates 222 connected to both of bottom surface of the circular ring 221 and rotatably mounted on the U-shaped curved portion 212, an attachment protrusion 223 mounted to project outwardly from one side ring support plate 222 so that the bucket 22 can be positioned by attached to an electromagnet 2131 when the ring support plate 222 is rotated through a certain angle by centrifugal force due to rotation of the rotor head portion 21. A decanting kit 30 is inserted into the hole 2211 of the circular ring 221, and a ring support plate fastening hole 2212, which is formed by being biased outwardly, is formed in the circular ring 221, and the circular ring 221 and the ring support plates 222 are connected through the ring support plate fastening hole 2212. When the attachment protrusion 223 mounted on one side of the ring support plate 222 is attached to the electromagnet 2131, the lower side of the decanting kit 30 is positioned higher than the upper side so that the centrifuged sample is discharged from the first chamber 31 to the second chamber 32 of the decanting kit. Accordingly, the portion of the ring support plate 222 on which the attachment protrusions 223 are mounted is formed to be inclined at a certain angle θ such that the lower side is positioned higher than the upper side. Specifically, the decanting kit 30 comprises a first chamber 31 in which a sample to be centrifuged, such as blood, is inserted, a floater (not shown) inserted into the inner side of the first chamber 31 and moving up and down by buoyancy, and a second chamber 32 in which the upper side of the floater of the centrifuged sample is flew by attaching the attachment protrusion 223 by magnetic force of the electromagnet 2131 as a power supply. The attachment protrusions 223 are attached to the electromagnet 2131 when DC power is applied to the electromagnet 2131 to generate magnetic force while the bucket 22 is tilted by centrifugal force. Once the attachment protrusions 223 are attached to the electromagnet 2131, the components of the sample on the upper side of the floater centrifuged in the first chamber 31 can be introduced into the second chamber 32 for separation.

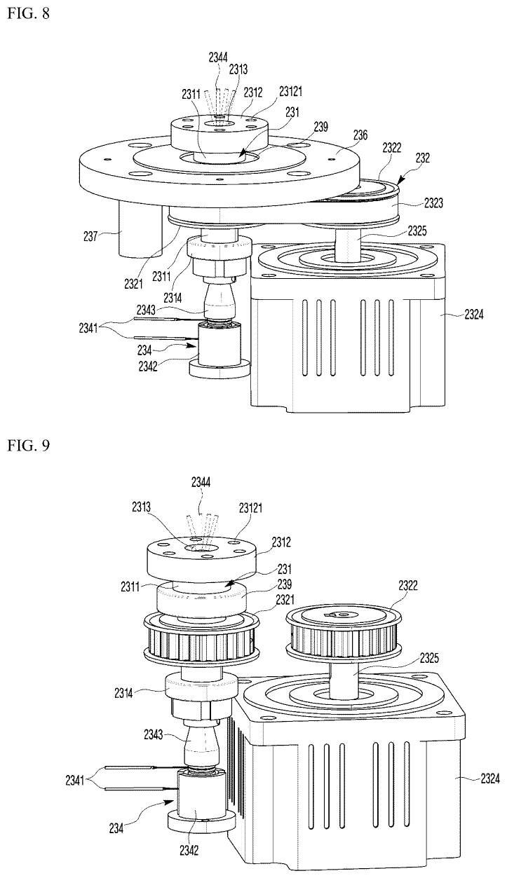

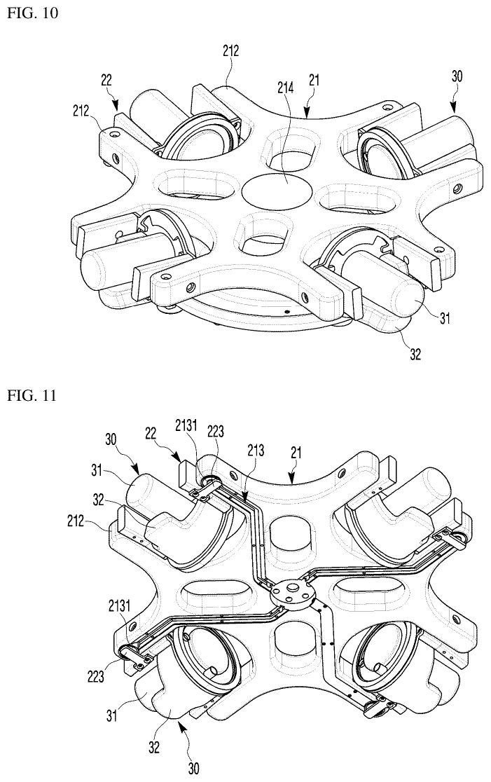

FIGS. 7 through 9 is shown for a drive unit 23. The drive unit 23 includes a rotating shaft portion 231 mounted on a central bottom surface of the rotor head unit 21, a driving transmission portion 232 that transmits a driving force to the rotating shaft portion 231, and a power supply portion 234 that is connected to the rotating shaft portion 231 and supplies DC power to the bucket fixing portion 213. The driving transmission portion 232 is mounted on a fixing plate 233, and a cap 235 having a hole formed in the center is mounted on the upper side of the fixing plate 233. On the inside of the cap 235, a shaft fixing plate 236 is mounted for fixing the rotating shaft portion 231, and the rotating shaft portion 231 is mounted in the center of the shaft fixing plate 236 with bearing support by the bearing portion 239. The shaft fixing plate 236 has an upper part fixed on the inner side of the cap 235 and a lower part fixed by a support stick 237 mounted on the upper part of the fixing plate 233. The rotating shaft portion 231 comprises a rotating shaft 2311, a shaft joint 2312 formed at the top of the rotating shaft 2311 and inserted into the lower joint groove 216 of the rotor head unit 21, a wire through hole 2313 formed at the center of the rotating shaft 2311 through which an electric wire 2344 from the power supply portion 234 passes, and a rotating joint 2314 connected to the power supply portion 234 at the bottom of the rotating shaft 2311. A fastening hole 23121 is formed in the shaft joint 2312, and a fastening member is engaged through the upper joint groove 215 of the rotor head unit 21 to connect the rotating shaft portion 231 and the rotor head unit 21. In addition, a driving transmission portion 232 is connected to the rotating shaft 2311 to transmit a rotational force to the rotating shaft portion 231. The driving transmission portion 232 consists of a driven belt pulley 2321 mounted on the rotating shaft 2311, a driving pulley 2322 that transmits rotational force to the driven pulley 2321, and a motor 2324 that transmits rotational force to the driving pulley 2322. The driving pulley 2322 is mounted on a motor shaft 2325 of the motor 2324 to transmit the rotational force of the motor 2324 to the driven pulley 2321. The means for transmitting rotational force from the driving pulley 2322 to the driven pulley 2321 is a belt 2323. The belt 2323 may be a timing belt or a V-belt. The power supply portion 234 utilizes a slip ring. The slip ring typically consists of a stator 2342 and a rotor 2343, with an incoming electric wire 2341 connected to the stator 2342, which supplies power to the rotor 2343. An electric wire 2344 leading from the rotor 2343 is connected to an electromagnet 2131 of the bucket fixing portion 213 through a wire through hole 2313 formed in the center of the rotation shaft 2311. The slip ring may be contact type or non-contact type. The fixing plate 233 is secured to the base plate 17 by fixing plate supports 238.

FIGS. 10 and 11 illustrate the rotor head unit 21 and bucket 22 being rotated by centrifugal force and then held in position by an electromagnet. As shown in the drawing, when the bucket 22 is tilted to a certain angle by centrifugal force, power is applied to electromagnet 2131 to form a magnetic force. When power is applied to the electromagnet 2131, a magnetic force is formed, and the attachment protrusions 223 of the bucket 22 is attached to the electromagnet 2131 by the magnetic force. When the attachment protrusion 223 is attached to the electromagnet 2131, the decanting kit 30 is inclined at a certain angle θ, so that the centrifuged samples are moved from the first chamber 31 to the second chamber 32.

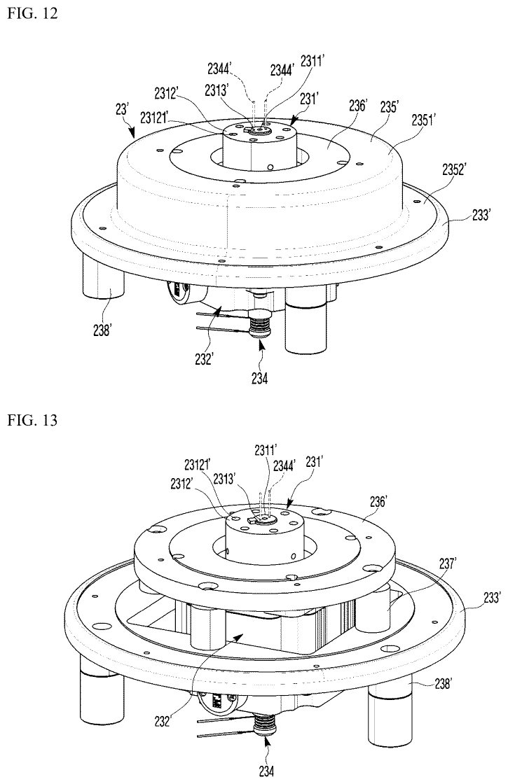

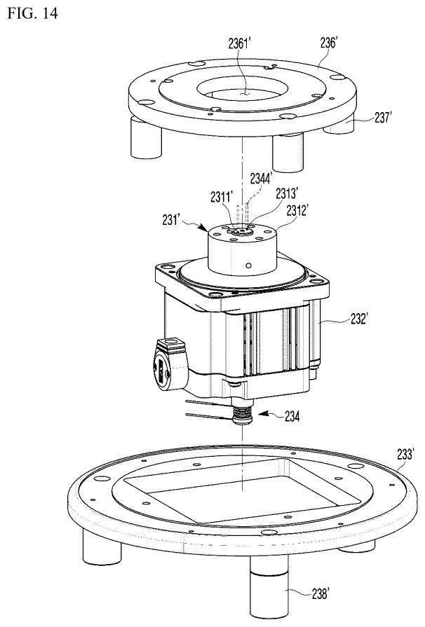

FIGS. 12 through 14 are drawings of a driving unit 23′ of a second embodiment of the swing rotor assembly 20. As shown in the drawings, the driving unit 23′ includes a rotating shaft portion 231′ mounted on a center bottom surface of the rotor head unit 21, a driving transmission portion 232′ transmitting a driving force to the rotating shaft portion 231′, a power supply portion 234′ connected to the rotating shaft portion 231′ and supplying DC power to the bucket fixing portion 213. The driving transmission portion 232′ is mounted on a fixing plate 233′, and a cap 235′ having a hole formed in the center is mounted on the upper side of the fixing plate 233′. On the inside of the cap 235′, a shaft fixing plate 236′ is mounted for fixing the rotating shaft portion 231′, and on the center bottom of the shaft fixing plate 236′, a driving transmission portion 232′ is mounted. The driving transmission portion 232′ consists of a motor and transmits rotational force to the rotating shaft portion 231′ through the motor. The shaft joint 2312′, which is fixed to the rotating shaft 2311′, is mounted so that it protrudes to the upper side through the through hole 2361′ formed in the center of the shaft fixing plate 236′. The shaft fixing plate 236′ has an upper part fixed on the inner side of the cap 235′ and a lower part fixed by a support stick 237′ mounted on the upper part of the fixing plate 233′. The rotating shaft portion 231′ comprises a rotating shaft 2311′ that connects with the motor 232′, a shaft joint 2312′ that is mounted on the top of the rotating shaft 2311′ and inserted into the lower joint groove 216 of the rotor head unit 21, and a pair of wire through holes 2313′ formed on both sides of the center of the rotating shaft 2311′ through which a pair of electric wires 2344′ from the power supply portion 234′ pass. The power supply portion 234′ is connected to the bottom of the rotation shaft 2311′. A fastening hole 23121′ is formed in the shaft joint 2312′, and a fastening member is engaged through the upper joint groove 215 of the rotor head unit 21 to connect the rotating shaft portion 231′ and the rotor head unit 21. The fixing plate 233′ is fixed to the base plate 17 by the fixing plate support 238′. The power supply portion 234′ utilizes a slip ring. The slip ring generally consists of a stator and a rotor, the specific configuration of which is the same as the power supply portion 234 of the driving unit 23 of the first embodiment, so the explanation of the specific configuration will be omitted. As described above, an incoming electric wire is connected to the stator and supplies power to the rotor. Electric wires 2344′ from the rotor are connected to the electromagnet 2131 of the bucket fixing portion 213 through wire through holes 2313′ formed on either side of the center of the rotation shaft 2311′. The slip ring may be contact type or non-contact type.

The operation of the swing rotor assembly 20 for centrifuge according to the present invention having the configuration will be described in detail as follows.

First, as illustrated in FIG. 2, the swing rotor assembly 20 of the present invention is mounted in the housing of the centrifuge 1 and electrically connected with a controller 14 of the centrifuge 1, and the component separation (centrifugation) of the sample contained in the decanting kit 30 accommodated in the bucket 22 of the rotor head unit 21 is enabled through horizontal rotation of the rotor head unit 21 in connection with the device driving according to the operation of centrifuge 1.

Describing the operation of the swing rotor assembly 20 of the present invention, as shown in the drawing a decanting kit 30 is inserted into the bucket 22, with a suitable amount of sample pre-filled into the first chamber 31 of the decanting kit 30.

When the decanting kit 30 is inserted in the bucket 22, the motors 2324, 232′ are driven. By driving the motor, the rotor head unit 21 is rotated, and the sample injected into the interior of the decanting kit 30 is centrifuged by the density difference accordingly. The centrifuged sample is separated up and down by the density difference, and a floater is positioned at the boundary line.

When the centrifugation is completed, the bucket 22 is kept at a certain angle by the bucket fixing portion 213, and is inclined at a certain angle for a certain time so that the centrifuged desired sample on the upper of the floater can be moved from the first chamber 31 to the second chamber 32 of the decanting kit 30.

Thereby, the components comprising the sample contained in the decanting kit 30 receptively mounted in each of the buckets 22 are separated from each other by a density difference. For example, in the case of blood, in the lower part of the first chamber 31, red blood cells, which are the densest component, are concentrated, followed by the buffy coat composed of white blood cells and platelets, which have the next highest density, and finally plasma, which has the lowest density. At the upper of the floater are the remaining components, except for red blood cells.

The centrifugation step may be performed more than once. If necessary, if the first centrifuged sample is transferred to the second chamber 32, it can be centrifuged a second time to separate the red blood cells from the rest of the components, as red blood cell components may be present in the second chamber 32.

When the component separation is complete, the decanting kit 30 is removed, and the sample in the second chamber 32 of the decanting kit 30 is extracted.

The above description just illustrates the technical spirit of the present invention and various changes, modifications, and substitutions can be made by those skilled in the art to which the present invention pertains without departing from an essential characteristic of the present invention. Therefore, the embodiments and the accompanying drawings disclosed in the present invention are used to not limit but describe the technical spirit of the present invention and the scope of the technical spirit of the present invention is not limited by the embodiments and the accompanying drawings. The protective scope of the present invention should be construed based on the following claims, and all the techniques in the equivalent scope thereof should be construed as falling within the scope of the present invention.

1. A swing rotor assembly for centrifuge that is mounted and rotated inside a housing of the centrifuge, the swing rotor assembly comprising:
a rotor head unit consisting of a U-shaped curved portion formed symmetrically to mount the bucket and a bucket fixing portion formed on one side of the bottom surface of the U-shaped curved portion to fix the position of the decanting kit tilted by centrifugal force;
a bucket in which a decanting kit is inserted and mounted, installed in the U-shaped curved portion, and rotated up and down by centrifugal force according to the rotation of the rotor head unit; and
a driving unit consisting of a rotating shaft portion mounted on the central bottom of the rotor head unit, a driving transmission portion that transmits driving power to the rotating shaft portion, and a power supply portion connected to the rotating shaft portion to supply DC power to the bucket fixing portion.

2. The swing rotor assembly of claim 1, wherein the bucket fixing portion is configured by an electromagnet mounted on the bottom end of one side of the U-shaped curved portion and operated by receiving DC power from the power supply portion.

3. The swing rotor assembly of claim 2, wherein the bucket is configured by a circular ring in which the decanting kit is inserted and mounted, a pair of ring support plates connected to both of bottom surface of the circular ring and rotatably mounted on the U-shaped curved portion, and an attachment protrusion mounted on the ring support plate corresponding to the position of the electromagnet in order to be attached to the electromagnet when the ring support plate rotates at a certain angle by centrifugal force.

4. The swing rotor assembly of claim 3, wherein the driving transmission portion is configured by a driven belt pulley mounted on the rotating shaft portion to receive rotational force, a driving belt pulley that receives rotational force from the motor to transmit rotational force to the driven belt pulley, a driving transmission belt connecting the driving belt pulley and the driven belt pulley, and a motor that rotates the driving belt pulley.

5. The swing rotor assembly of claim 4, wherein the driving transmission belt is configured by timing belt or V-belt.

6. The swing rotor assembly of claim 3, wherein the driving transmission portion is configured by a motor driving the rotating shaft portion.

7. The swing rotor assembly of claim 4, wherein the power supply portion is configured by a slip ring to be mounted on the rotating shaft portion and to supply DC power to the electromagnet.

8. The swing rotor assembly of claim 6, wherein the power supply portion is configured by a slip ring to be mounted on the rotating shaft portion and to supply DC power to the electromagnet.
